(19) United States
(12) Patent Application Publication
(10) Pub. No.: US 2017/0069349 A1
(43) Pub. Date: Mar. 9, 2017

(54) APPARATUS AND METHOD FOR GENERATING A VIDEO FILE BY A PRESENTER OF THE VIDEO

(71) Applicant: BIGVU INC, NEW YORK, NY (US)

(72) Inventors: Hervé MUYAL, Gland (CH); David AMSELEM, Meitar (IL)

(73) Assignee: BIGVU INC

(21) Appl. No.: 15/257,941

(22) Filed: Sep. 7, 2016

Related U.S. Application Data
(60) Provisional application No. 62/215,050, filed on Sep. 7, 2015.

(51) Int. Cl. G11B 27/031; G11B 31/00; G06T 11/60; G11B 27/36; G06K 9/00; G11B 27/10; G11B 27/34

(52) U.S. Cl. CPC G11B 27/031; G11B 27/102; G11B 31/006; G11B 27/34; G11B 27/36; G06K 9/00765; G06K 9/00664; G06T 11/60; G06T 2207/20144; G06T 2207/10016

(57) ABSTRACT

The subject matter discloses a method of composing a video file, comprising receiving a video file from a mobile electronic device, the video is captured in response to a command from a presenter shown in the video, automatically identifying at least two video scenes in the video according to properties of the video file, determining video properties for the two or more scenes, at least one video property is different among the two or more scenes and composing one video file out of said at least two video scenes

### BACKGROUND OF THE INVENTION

In recent years, newsrooms in the traditional media have been cutting staff, causing greater numbers of talented journalists to take the freelance route. For freelance journalists, video is hard to produce, and it's a long process. It requires skills and dedicated equipment.

At their day to day work, journalists require a dedicated platform with a unique authoring tool-set to capture their presentation of breaking news and produce professional quality video reports, captured with diverse types of video devices and assembled from the comfort of their desks. Such video devices may be, video cameras, webcams, mobile telephones, and the like. The journalist dedicated platform should meet the requirements to fully cover the life cycle of news production. Journalists should have the tools they need at their fingertips to produce a professional video report in a snap.

Such a capable and powerful platform may create a challenge by allowing viewers utilizing the platform to become active participants with granted permissions to select, watch, react, and share stored video content. The journalists should have the appropriate tools to easily create such video deliverables while being protected and secured from unauthorized participants.

### SUMMARY OF THE INVENTION

The present invention discloses a method for creating a video file out of video content prepared by a presenter which owns the video content, in order to share it with multiple video consumers. The method comprises a setup stage which defines the video content properties. The video content properties may be such as, the speed of the video content, the running time, external content of text or sound, and the like. The setup state may comprise a process of receiving an interface such as a script which can be displayed to a presenter while recording the video. In some cases, said method also comprises a process of receiving the presenter's location on the screen during the time of recording the video. In other some cases, the script can be displayed on a display device of a computerized mobile device while the video shot is captured.

The method disclosed in the present invention may also comprise a process for receiving a presenter input concerning the video properties after capturing a video shot. In some cases, the method disclosed in the present invention may also comprise additional processes to configure the video properties, such as trimming the audio parts, removing a portion of the video file and convert the audio parts to an audio tracks captured by the computerized device. In some other cases, the method may comprise a process for automatically terminating the video shot in a predefined time after finishing displaying the script.

In some cases, the processes for configuring the video properties may comprise receiving the presenter's input concerning progress speed of the script. The speed configuration may comprise the number of frames during the text, the time, or the number of text lines displayed per time. The process of configuring the video properties may also comprise the option to issue an alert to the presenter when the video capturing begins. The presenter utilizes the script may also have the option to capture a background which can be used when shooting the video. For example, the presenter may choose an image as a background for the video shot. In some cases, the presenter may be able to receive an image from a website page or from a social media application as a background. In some other cases, the presenter may also be able to present an additional text received from a social media application such as Tweeter.

In some case, the processes for configuring the video properties may also provide with an option to adjust and configure the video properties after the video shot is captured. For example, a presenter may change the background, adjust the script speed time, and the like, after the video shot is captured. In some embodiments of the method disclosed in the present invention a presenter may be able to compose a video file out of two or more video scenes in the video file according to the properties of the video file. Thus, the method may comprise a process to identify two or more video scenes in a video file which at least one video property is different between the two (or more) video scenes. Then, a new video file composed of the two video scenes can be created. In some cases, a media file from a website page can be added to the video file received from the mobile electronic device of the presenter. The presenter may utilize a camera installed in the mobile electronic device.

The method discloses in the present invention may also comprise the option to change the video properties after the video file composing of at least two scenes has completed. Such changes may comprise changing the background, adding media content from a website page, replace the background in some of the scenes of the newly created video file, trimming and changing the audio of the video file, changing the script start and stop points, and the like. In some cases, the presenter may also have the option to add a brand, text or an image to the scenes in the new video file.

### BRIEF DESCRIPTION OF THE FIGURES

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are designated by the same numerals or letters.

FIG. 1 shows a computerized system for creating a video file which can be uploaded to a content control system by a presenter of the video, according to exemplary embodiments of the subject matter;

FIG. 2 shows a computerized method for creating a video from a video content created by a presenter, according to exemplary embodiments of the subject matter;

FIG. 3 shows an interface of a display device on which the presenter is shown, said interface shows a prompter loaded and Audio Levels, according to exemplary embodiments of the subject matter;

FIG. 4 shows a menu displayed on a display device on which the presenter is shown, said menu is displayed to the presenter after capturing of a video shot, according to exemplary embodiments of the subject matter;

FIG. 5 shows a teleprompter interface displayed on a display device on which the presenter is shown, said prompter interface enables the presenter to adjust prompter properties, according to exemplary embodiments of the subject matter;

FIG. 6 shows a timeline interface displayed on a display device on which the Video Appears with a timeline with audio waveform and IN/OUT Markers, according to exemplary embodiments of the present invention;

FIG. 7A shows a scene interface displayed on a display device on which the presenter is able to adjust and edit each scene separately, according to exemplary embodiments of the present invention;

FIG. 7B shows an edited scene appears in a scene box with an icon of delivered from a social network application, according to exemplary embodiments of the present invention;

FIG. 8 shows a timeline interface displayed on a display device on which the Video Appears with a timeline of the scenes enabling the presenter to trim the video, according to exemplary embodiments of the present invention;

FIG. 9 shows a computerized method for composing a video file by a presenter of the video, according to exemplary embodiments of the subject matter, according to exemplary embodiments of the present invention; and,

FIG. 10 schematically shows how an interview is displayed on a presenter's display device, according to exemplary embodiments of the present invention.

### DETAILED DESCRIPTION OF THE INVENTION

The present invention discloses a method for creating, editing, analyzing and sharing a digital video content by a presenter of the video content. The presenter of the video content may be the person who owns the video content and may seek to share the video content among video content consumers. In some cases, the presenter may be the person who uploaded the video content to a dedicated content control system and thereby granted with ownership permissions. In some other cases, the presenter may be a person granted with ownership permissions on some of the video content. Such ownership permissions may allow the presenter to manage the lifecycle of the video content. Managing the lifecycle of the video content may comprise actions such as, upload, edit, share, grant permissions to other participants, delete, and the like.

In some embodiments of the present invention, the lifecycle of the video content may begin by the presenter of the video content by adding video files to a content control system. The process of adding video files may be supported by a dedicate interface such as a website interface, a command line interface, a programmable application interface, and the like. In some cases, the lifecycle of the video file may also comprise inputting a header topic into the content control system. The content control system disclosed in the present invention can be a computerized device such as a personal computer, server, cluster of servers, mobile electronic device, a tablet computer, a computerized mobile device, laptop and the like. In some cases, the content control system may be operated on a server connected to communication networks such as LAN, WAN, Internet connection and others. The content control system may also be configured to receive communication from presenter and participants seeking to manage, control or consume visual content stored in the content control system.

In possible embodiments of the present invention, the process of preparing and adding video file to the content control system may be supported by a dedicated interface such as scripts controlled by the video content system. The script, or the scripts, may be prepared by the presenter, or sent from a remote device, such as from a colleague of the presenter, or a combination thereof. In some cases, the script may be capable to determine the progress speed of the script, or the total time of the video. In some other cases, the script prepared by the presenter may be operated in order to capture the presenter speaking in front of the camera. Thus, the presenter may also be provided with the option to edit the script, add or remove parts in the script. For example, a presenter may utilize the camera integrated in a mobile device to shoot a video scene. The presenter may also have the option to upload the video content from the mobile device and then, the presenter may have the option to edit a script for determining the video content properties such as the speed of the video content, the running time, external content of text or sound, and the like. The presenter may utilize the script in order to link an external sound file that may be played in some parts during the video content display, or add an option for subtitles and text displayed during the video content display. In some other cases, the content added to the script may be automatically translated to other languages and be integrated as an additional content layer to the video. The content control system may also be configured to provide a graphic interface to the presenters in order to edit the script. Thus, the presenters may be able to manage and set the video properties via a graphic interface and the content control system may translate it to a script capable to run at the client computerized device.

In some embodiments of the present invention the content control system may provide the presenter with the option to extract and/or add information provided by social networks such as Twitter and Facebook. For example, a presenter may have the option to inject text from Twitter into a video content the presenter owns. The presenter may also have the option to define the time duration and the exact place in the screen of the injected text. The content system may also have search capabilities which can be utilized by people. The search query may be generated by the content control system, according to the video content properties defined by the presenter. The video content properties may be defined automatically or by the presenter via a dedicated interface or a script inputted into the system. The video file may comprise a news article, a greeting, an opinion and the like. The content control system enables reporters and every person to record themselves speaking using a camera of a mobile electronic device in order to create a quality video and distribute it. For example, in response to a search query defined by the title of the video content.

In some cases, after one or more video shots captured by a camera of a mobile device operated by the presenter, the video file can be composed, as detailed below. The composed video can be distributed to subscribers of the presenter, for example via social networks or messages such as email or SMS. In some cases, the composed video may also be distributed via a media corporation such as CNN, BBC and the like.

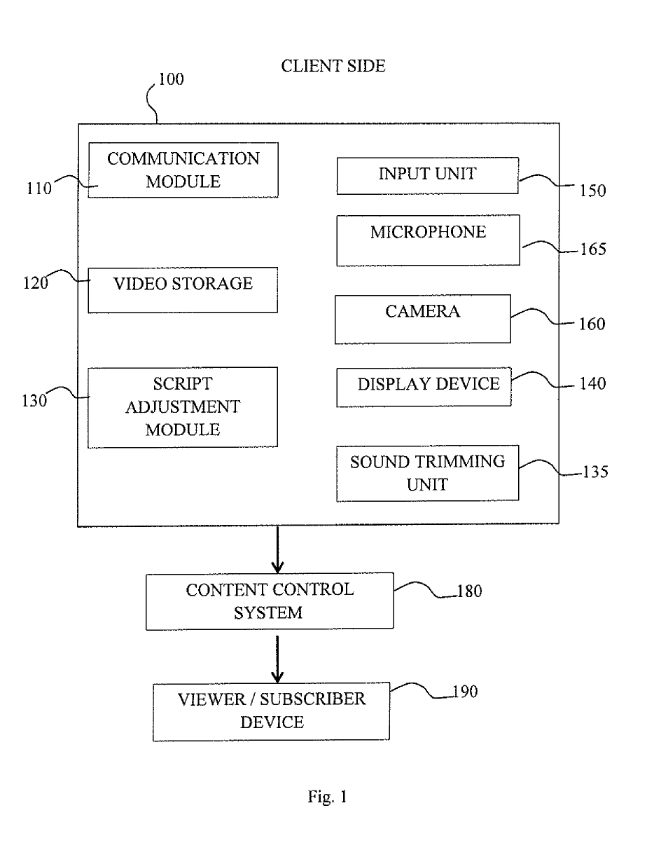

FIG. 1 shows a computerized system for creating a video file which can be uploaded to a content control system by a presenter of the video, according to exemplary embodiments of the subject matter. The computerized system comprises a client side 100, which can be a mobile electronic device, a notebook or a desktop computer with a webcam used by a presenter of the video file, such as a laptop, tablet or smartphone device. The client side comprises a camera 160 used to capture video shots and a microphone 165 to capture audio. The camera 160 may be a forward camera or rear camera, an infra-red camera and the like. In some cases, the camera 160 and microphone 165 may be external to the mobile electronic device 100, connected via an electronic cable or using a wireless communication protocol such as IEEE 802.11. The client side 100 may also comprise an input unit 150 designed to capture the content provided by the camera 160 and its corresponding audio provided by the microphone 165, convert the audio and visual content to a digital video file and store it in video storage 120. The display device 140 of the client side 100 enables the presenter to view and listen to the video content by accessing the video file stored in the video storage 120. The input unit 150 can also be configured to enable the presenter to insert information or commands into the client side 100. In some cases, the input unit 150 may introduce to the presenter a graphic interface that allows to configure the properties of the video content. For example, the presenter may adjust the video progress speed or the presenter's location on the scene via a physical touch or touchless gesture interface or virtual buttons or a predefined menu. The client side 100 may also comprise a script adjustment module 130 enabling the presenter to adjust script designed to configure the properties of the video content. The script may be displayed to the presenter during the time the video shots are captured by the camera 160, or in some cases, after the video shot has ended. In some cases, after capturing a portion of the video shot, the presenter may be able to add, remove or edit the script. The client side 100 also comprises a communication module 110 used to transmit the video file from the video storage 120 to the content control system 180, from which the video file can be edited and transmitted to a viewer/subscriber device 190 according to the viewer's preferences, or according to any set of rules stored in the content control system 180.

In some cases, the communication module 110 may be configured to transmit the video file in real-time. Thus, the video captured by the input unit 150 and converted to a video file may be transmitted to the content control system 180, automatically after the conversion process of the video file has completed. The client side 100 also comprises a sound trimming unit 135 designed to convert the sound content provided by the microphone 165 to an audio track. In some cases, the sound trimming unit 135 may be configured to remove sections in the audio track of the video file, in which a background noise interferes with hearing the presenter's voice. The sound trimming unit 135 may also be configured to remove sound which may not be related or part of the presenter speak. In some embodiments of the present invention, the sound trimming unit 135 may be configured to sample the speaker's voice and then, per configuration settings or script commands, to remove background sounds and noise which may not belong to the presenter's speech. In some cases, the sound trimming unit 135 may provide an interface to the presenter operated client side 100 to approve a removal action performed by the sound trimming unit 135.

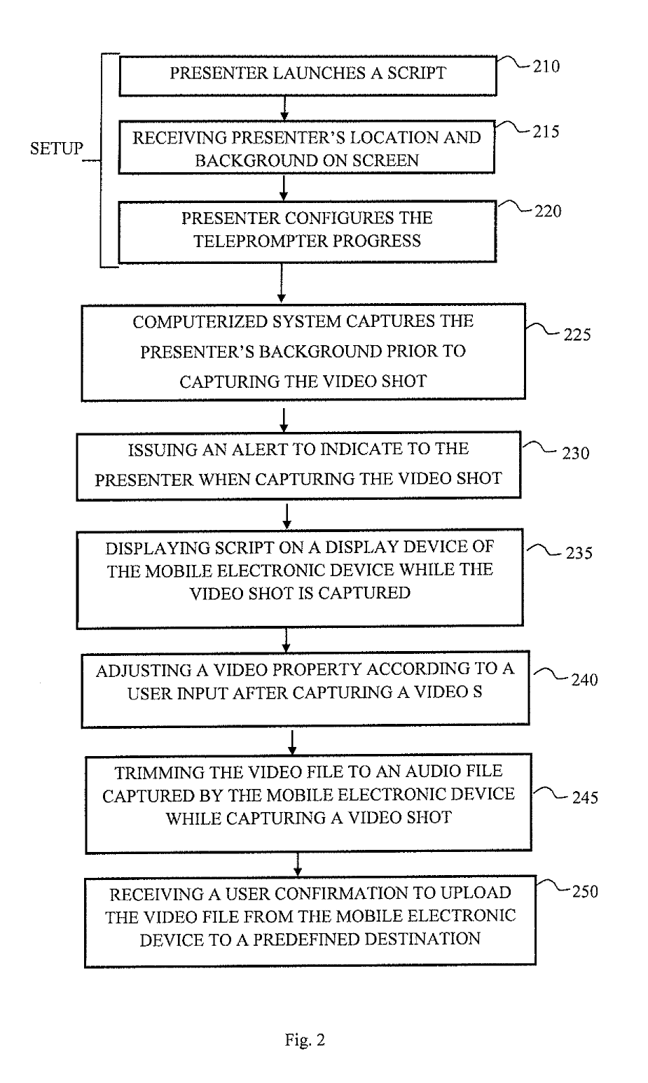

FIG. 2 shows a computerized method for creating a video file from a video content created by a presenter, according to exemplary embodiments of the subject matter. The method comprises a setup stage comprises step 210 which discloses a script launching by the presenter, onto a computerized system. The computerized system may be operated in a computerized device such as a notebook computer, a desktop computer with a webcam, a mobile telephone, and the like. The script may be typed by the presenter or another person, or may be transmitted from another electronic device, for example from a third party server, to the presenter's computerized device. The script can be stored in the storage of the presenter's computerized device. In some cases, the computerized system may be configured to associate the script with its corresponded video content and store it at the video storage, as disclosed above. The setup stage may also comprise step 215 disclosing receiving the presenter's location on the screen when the video shot is captured. In some cases, the presenter may have an option to utilize a graphic interface for adjusting the location of the video, according to the background. For example, the presenter may use a location interface in which the presenter moves his/her fingers on the computerized device's touch screen. In some embodiments of the present invention, the presenter may have the option to determine his/her location from a multiple choice menu, as the choices may be “right”, “center-right”, “center”, “center-left”, “left”. Presenter's location may be used for image quality optimization, define more precisely the presenter's desirable part of the image, and to operate the background removal processing. In some cases, the computerized system may provide a teleprompter option for the presenter. Such teleprompter option may be a text displayed on the screen during the process of the video filming. The text appearing on the screen may comprise the text the presenter may say. Thus, the setup stage may also comprise step 220 disclosing configuring the teleprompter progress. The configuration of the teleprompter progress may be defined as a number of words displayed on the screen per second/minute, as the total duration of the video shot, or in another way desired by a person skilled in the art.

Step 225 discloses the computerized system capturing the presenter's background prior to capturing the video shot. In some cases, capturing the background may take a predefined duration, in terms of seconds, and terminate with an alert, a notification or a message displayed on the display device of the presenter's computerized mobile device. Step 225 is an optional step and might be unnecessary, for example using a blue/green screen or with matting algorithms, for example algorithms that require a scribble interface.

Step 230 discloses issuing an alert which indicates to the presenter when capturing the video shot begins. The alert may be a played sound. For example in a countdown from five to zero. The alert may be played by the display device of the presenter's computerized device. In some cases, the computerized system may be configured to start automatically to capture the video shot, after the alert has finished. Step 235 discloses displaying script on a display device of the computerized device during the time the video shot is captured. This step is also optional as some presenters do not need the script while taking the video shot. Moreover, some presenters may prefer using a rear camera of the computerized device, so they cannot see the screen with the script. The script may be displayed in a predefined speed, for example as inputted by the presenter prior to the video shot. The script may enable the presenter the possibility to be a sole creator of a quality video and save time in preparing to a video shot, without the necessity of memorizing the script nor with an aid of a crew in addition to the presenter.

Step 240 discloses adjusting video content properties according to a presenter input after capturing a video shot. Such video properties may be the teleprompter progress setting, audio level, location of the presenter and the like. Said adjustment may be performed via a specific interface as detailed below.

Step 245 discloses trimming the video file to an audio track captured by the mobile electronic device while capturing video content. Trimming the video file improves the video, for example by removing parts of the video in which the presenter does not speak. Naturally, the presenter may pause speaking, for example when breathing, and the trimming comprises identifying time slots in the video file that are longer than the natural breaks. The trimming discloses identifying audio levels throughout the video timeline, for example the audio levels in various time intervals throughout the video shot. Trimming the video may also remove a section in the video in which a background noise interferes with hearing the presenter's voice. Step 250 discloses receiving a user confirmation to upload the video file from the mobile electronic device to a predefined destination.

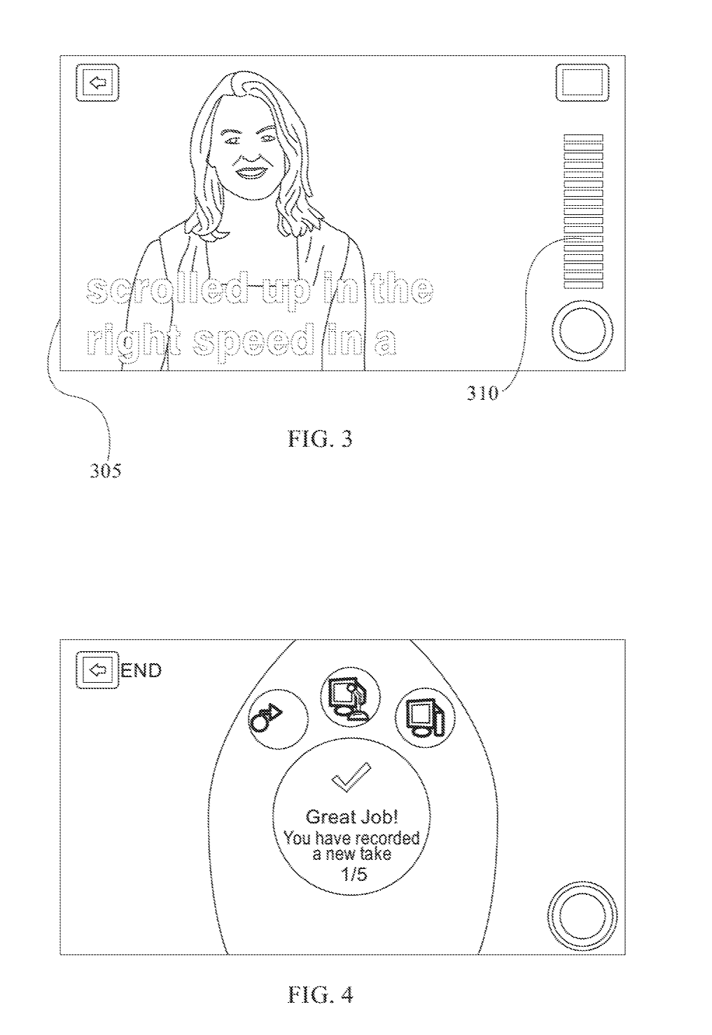

FIG. 3 shows a video shot interface of a display device on which the presenter is shown, said interface shows a teleprompter loaded and Audio Levels, according to exemplary embodiments of the subject matter. The video shot interface 305 which may be displayed on the presenter's display device when the camera captures a video shot of the article. The video shot interface 305 also shows an alert countdown before beginning to capture a video shot. The video shot interface 305 also comprise audio level scale 310 which can display the audio level at which the presenter's voice is recorded, and the progression of the script during the video shot, for example whether the presenter already saw half of the script or just 20% of the script.

FIG. 4 shows a menu displayed on a display device on which the presenter is shown, said menu is displayed to the presenter after capturing of a video shot, according to exemplary embodiments of the subject matter. The menu may be displayed after a video shot capturing has completed, and enables the presenter to adjust or update at least some properties of the next video shots to be captured. The properties may be prompter progress speed, edit the script, and the like. The menu also enables the presenter to capture another video take, using a virtual or physical button on the menu.

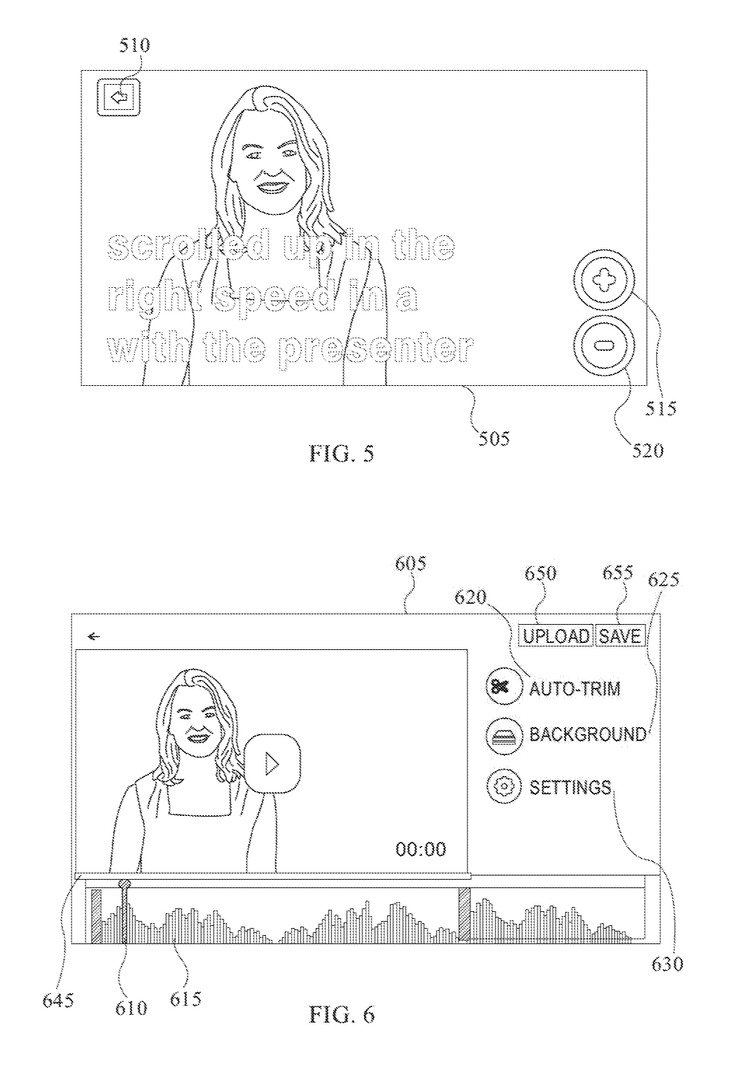

FIG. 5 shows a teleprompter interface displayed on a display device on which the presenter is shown, said prompter interface enables the presenter to adjust prompter properties, according to exemplary embodiments of the subject matter. FIG. 5 shows a teleprompter interface 505 with the presenter which may reach the teleprompter interface 505 by pressing a prompter icon on the main menu of the computerized system. Teleprompter interface 505 may comprise an exit button 510 which may leave the teleprompter screen and lead to a different part of the interface. The teleprompter interface 505 also comprises a plus button 515 and a minus button 520 indicating to the presenter how to raise or reduce the teleprompter progress speed. For example, in case the progress of the text which appears in the teleprompter interface 505 is faster than the visual content the presenter can utilize minus button 520 to reduce the speed of the text progress and adjust it to the visual content.

FIG. 6 shows a timeline interface displayed on a display device on which the video appears with a timeline with audio waveform and IN/OUT Markers, according exemplary embodiments of the present invention. FIG. 6 comprises a display device interface 605 utilized by the video content owner to manage the lifecycle of a video content. Display device interface 605 comprises a timeline interface 645 enables the presenter to track the progress of the video file and edit the video during the progress. The display device interface 605 also comprises a ruler runner 610 configured to move along the timeline interface 645 and to present the progress point of the video content. The display device interface 605 also comprises s sound progress interface 615 presenting the sound track corresponded to the progress point of the visual content of the video file.

The display device interface 605 comprises an auto-trim button 620 enables the presenter to automatically trim the video to the audio. For example, in case the video file is displayed in the display device interface 605 and the presenter decide to trim the video file in order to cut-out parts of silence, the presenter may utilize the auto-trim button 620 to clean-out the parts with the silence. In one embodiment the computerized system automatically identifies intervals in the video of a minimal predefined duration, for example 0.5 sec as indicated by the “Trim Level settings”. In some exemplary cases, the computerized system determines whether the audio level in the intervals is higher than a predefined threshold, and if the audio is lower than the threshold, the interval is marked for further processing. Trimming also allows to automatically pre-select a subset of the script recorded by the presenter in order to keep it as part of the final video file.

Display device interface 605 also comprises an upload 650 in order to upload the video file to a content control system as disclosed above, and save it with via save button 655. The display device interface 605 also comprises background button 625 utilized to add a virtual background to the video content, for example a background represented by an image, or a color can be added to the video content. In some cases, the presenter can press the auto trim button, the video goes to the beginning of next audio section where the following progression is performed. The background button 625 may also introduce a green-screen option to the presenter. Thus, upon choosing the green-screen option, the presenter may be able to pick a particular space or a specific color, and to convert it to a green-screen space. The presenter may be able to add diverse virtual backgrounds as wallpapers attached to the green-screen space In case the user wished to adjust the background, any other computerized system operated on a user device can be applied to change the background of the video behind the presenter. The presenter may also adjust the lighting in the area where the video is captured. The same video file can be saved in several versions with various computerized systems operated on different user devices, for example to enable the video file to be branded differently for varied customer types. In some cases, the computerized system may begin capturing the video automatically when the presenter's voice is detected.

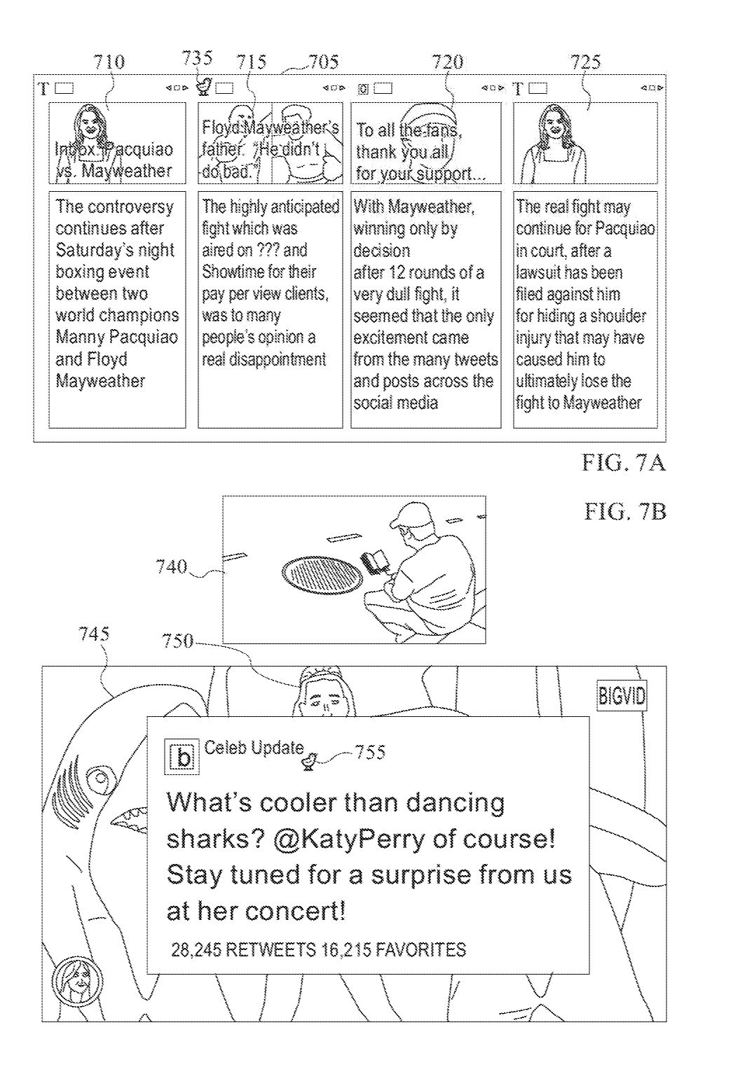

FIG. 7A shows a scene interface displayed on a display device on which the presenter is able to adjust and edit each scene separately, according to exemplary embodiments of the present invention. FIG. 7A shows a scene interface 705 which can show multiple scenes separately, for example scene interface 705 shows scene box 710, 715, 729 and 725 wherein each scene box shows a separated scene. In addition, the scene interface 705 comprises the portion of the script for the relevant scene. For example, scene in scene box 710 comprises words number 23 to 29. In some cases, some of the words in a scene may be highlighted, according to a predefined set of rules.

The scene interface 705 may also enable the presenter to create a sequence of video from a social network post, or from content residing at a link. The sequence of video comprises several items extracted from the link, for example the sequence begins with an image or several images, then the text, and the presenter has it all automatically. The presenter can select the content or the link according to results from the search query generated according to the script. In such search query the key words which may be needed to be used can be automatically identified by the script and then the query is generated. In some cases, the video sequence is generated using a predefined automated template. For example, some templates define the difference level in the components of a social network post should be presented in the video sequence. For example, generating a video from the tweet of Tweeter icon 735 and locate it above the scene box such as scene box 715.

FIG. 7B shows an edited scene appears in a scene box with an icon of delivered from a social network application, according to exemplary embodiments of the present invention. FIG. 7B demonstrates an optional result in a possible embodiment of the present invention in which a predefined template may specify that the image from the tweet of picture 740 may be placed as background of the video. Then, a notification may appear from the top with the text of the tweet, and the twitter sender icon may also appear at the top left corner of the video box. FIG. 7B shows a scene box 745 which comprises a video content with a text box 750. Text box 750 comprises a text added by a script and provided by a social network application. Text box 750 also comprises a Tweeter icon 755 located at the upper left corner and indicates that the text appears in the text box 750 is provided by Tweeter.

In some cases, the scene interface may also enable the presenter to insert images that represent the video scenes as background. The presenter may utilize a script to insert an image or a video from a website or social network application into the scene box 745, such that the inserted image or video will replace the image of the presenter with a visual animation extracted from the social post. In some cases, the script may be utilized to generate a video which can be used as a background of a video scene by integrating a sequence of images stored in a specific web page, for example a Facebook album. For example, a presenter may choose an album on a social network application, or a sequence of images stored in a computerized system connected to a communication network, such the Internet. The presenter may be able to define the image sequence as the background of the newly prepared video content. The presenter may also be able to define the duration time between of each image in the sequence. In some cases, the video scenes may be defined by additional algorithms, for example algorithms which can utilize a number of words and/or audio activity per time slot or time interval. The video scene creation algorithm may automatically detect changes in the video scenes, according to audio activity in case a phrase starts or a longer/shorter duration as scenes cannot be more 7 or seconds long. In some cases, the scenes should be between 3 to 10 seconds long.

The method disclosed in the present invention also comprises process for automatic detection and identification of breathing points in a speech of a video presenter. The breathing points may be used to define or detect video scenes in which a specific event or command is required. Such event or command may be removing a portion of the video, replacing the background, or artificially moving the camera.

Said process for detection and identification of breathing points may comprise a step of analyzing the script and identifying the possible breathing points, such as commas and full stops in the text. Then, the system can define the time stamp of the breathing points, for example to define when the most important breathing pauses exist, by analyzing the signal of the audio track (speech to text algorithm). Once the process of identifying the candidates has completed, the breathing points can be evaluated, for example to determine whether or not the presenter took enough time to breathe, in case it can be a change point within the video scene. Said process may also analyze images of the video and utilize face recognition algorithms to define changes in the presenter face. For example, cases when the presenter's mouth is closed.

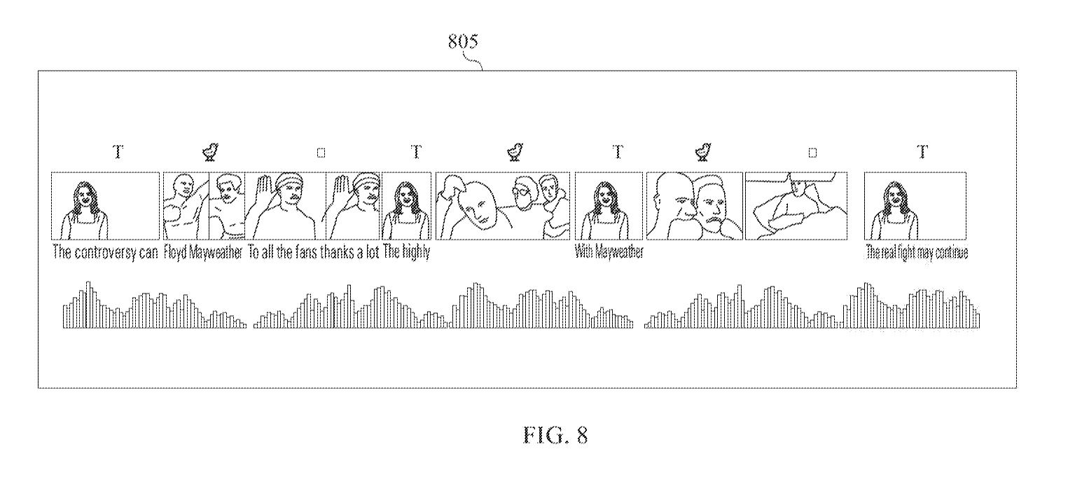

FIG. 8 shows a timeline interface displayed on a display device on which the video appears with a timeline of the video scenes, according to exemplary embodiments of the present invention. FIG. 8 shoes a timeline interface 805 which enables the presenter to adjust the video scenes durations, as identified in FIG. 7, in the case additional adjustments are needed over the algorithms adjustments, or in case it may need to be slightly adjusted. The timeline interface 805 shows a sequence of intervals as defined above, and shows which video scenes are to be shortened or extended in terms of duration.

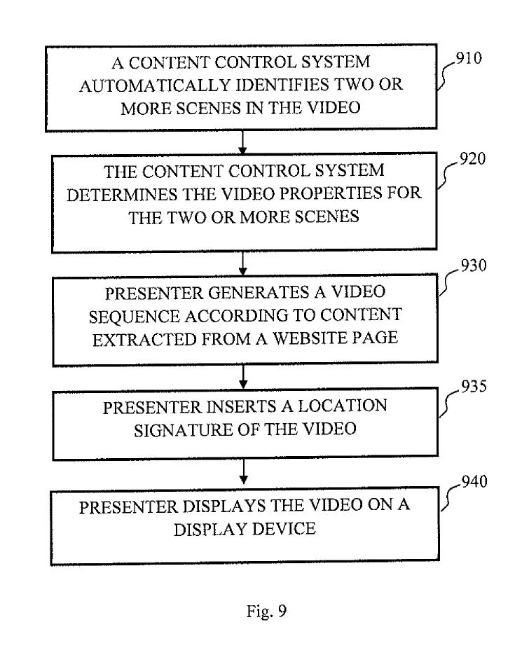

FIG. 9 discloses a computerized method for composing a video file by a presenter of the video, according to exemplary embodiments of the subject matter. The method can be performed after two or more video shots of the presenter are captured, as disclosed above. The steps of FIG. 9 can be performed by the presenter's computerized device, or partially in a server communicating with the presenter's computerized device. Step 910 discloses automatically identifying two or more scenes in the video according to properties of the video file, as detailed in FIG. 7. The video scenes may be identified by the content control system, according to the script as inputted into the presenter's device prior to capturing the video shots. The video scenes may be identified in accordance with analysis performed on images of the video, for example automatically recognizing that the presenter's lips are closed, or detecting that the presenter did not speak for more than a predefined threshold, such as 1.2 seconds. After the scenes are identified, step 920 discloses determining video properties for the two or more scenes, at least one video property is different among the two or more scenes. The video properties may be background, music, theme, presenter's location on the screen, camera angle or virtual movement, script progress speed and the like.

Step 930 discloses generating a video sequence according to content extracted from a web page, for example from a news website or from a social media post. The video sequence is automatically assembled from the content of the link, for example the title of the web page is displayed for 1.5 seconds, then the upper image for 2 seconds and the latter image for 1.5 seconds, as the scene associated with the video sequence has a duration of 1.5 seconds. The sequence may be generated according to a predefined automated formula or template, as detailed below. Step 935 discloses inserting a location signature of the video, for example Manhattan, for further analysis of to enhance distribution of the video file to subscribers according to geographic preferences of the subscribers. Step 940 discloses displaying the video on a display device, wherein the video is separated into the two or more scenes, with a background and a portion of the script for at least two of the two or more scenes. Creation of the video sequence may also comprise applying filters on least a portion of the images of the video, for example a black and white filter. The filters may be applied either on the background images or on the foreground content, for example the presenter's image. In some cases, the filters may be applied on the audio track only, or on a predefined portion of the video, for example the second scene, or only when the presenter appears.

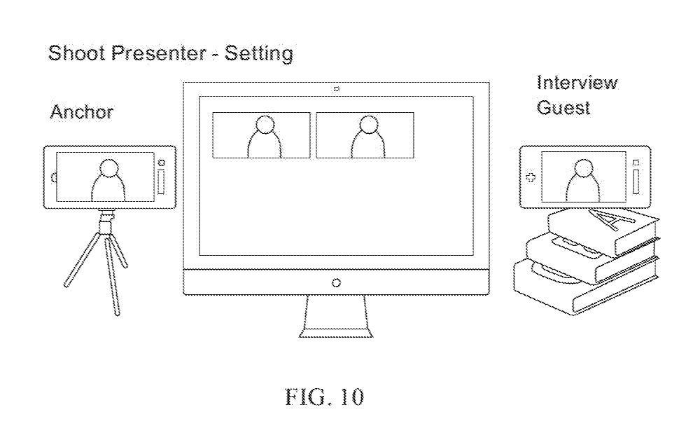

FIG. 10 schematically shows how an interview is displayed on a presenter's display device. The interview is a discussion between an anchor, which is the presenter, and a guest. The guest is also equipped with an electronic device, and may also have a client side of the connected to the presenter's client side, such as a mobile application.

The guest may be located in a remote location, relative to the presenter. The guest may download the mobile application, click on “Guest”, search for the name of the journalist or the presenter, and a message from the presenter directs the guest to the relevant page in the mobile application. Then, the presenter is notified that the interview may start when the guest is on the take page

After the interview begins, an audio channel is used to exchange audio files or streams between the presenter and the guest. In some cases, the video is recorded locally—in the GUEST app for the Guest electronic device, and the Presenter App for the presenter electronic device, and after the interview ends, the audio and video files from both electronic devices, of the presenter and the guest, are sent to a server.

Some text questions can be entered prior to the interview and read directly by the guest in the mobile application either in real-time or pre-loaded so that the guest may record the interview “offline” without the presenter being on the other side. The presenter listens to the guests in real-time and may mark interesting points said by the Guest in real-time. Questions, generated by the presenter, and answers, generated by the guest, may be displayed as a single sequence of scenes, as the scenes are cut according to a scene cutting algorithm. In some cases, video is presented only when the person is speaking and not when the person is listening. According to audio activity, the studio shows who is talking at a given moment.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A method of composing a video file, comprising:
receiving a video file from a mobile electronic device, the video is captured in response to a command from a presenter shown in the video;
automatically identifying at least two video scenes in the video according to properties of the video file;
determining video properties for the two or more scenes, at least one video property is different among the two or more scenes;
composing one video file out of said at least two video scenes.

2. The method of claim 1, further comprises extracting a media file from a website page and add the media file to the video file received from the mobile electronic device.

3. The method of claim 2, further comprises generating a video sequence used as a background for a scene of the two or more video scenes using the media file from a website page.

4. The method of claim 1, wherein receiving the presenter's background selection for one video scene of the two or more scenes, removing a first background and replace the removed background with a second background.

5. The method of claim 1, wherein the two or more scenes are identified according to breathing points in the video.

6. The method of claim 5, further comprises assigning a time code for the breathing points in the video.

7. The method of claim 1, wherein the two or more scenes are identified according to predefined stops in the script.

8. The method of claim 1, wherein the two or more scenes are identified by analyzing images and the related audio in the video.

9. The method of claim 1, further comprises displaying the video on a display device, wherein the video is separated into the two or more scenes, with a background and a portion of the script for at least two of the two or more scenes.

10. The method of claim 1, further comprises defining a camera angle for at least one of the two or more scenes.

11. The method of claim 1, further comprises determining a background of a scene of the two or more scenes according to the viewer of the composed video.

12. The method of claim 11, further wherein the background is determined according to a brand associated with the video, content of the video or the presenter.

13. A method for creating a video file, comprising:
during a setup stage, receiving a script to be displayed to a presenter while recording the video;
during a setup stage, receiving the presenter's location on the screen to identify the presenter's location while recording the video;
capturing a video shot of the presenter using a camera installed in mobile electronic device, said script is displayed while the video shot is captured;
saving said captured video shot and the displayed script into a digital video file.

14. The method of claim 13, wherein the script is displayed on a display device of the mobile electronic device while the video shot is captured.

15. The method of claim 13, wherein the script is projected from the mobile electronic device while the video shot is captured.

16. The method of claim 13, further comprises receiving the presenter input concerning a video property after capturing a video shot, said presenter input is inputted into an interface of the mobile electronic device.

17. The method of claim 13, further comprises trimming the video file to an audio track captured by the mobile electronic device while capturing a video take.

18. The method of claim 17, wherein the trimming comprises removing a portion of the video file.

19. The method of claim 18, wherein the removing a portion of the video file according to an audio property of the portion.

20. The method of claim 1, further comprises receiving the presenter's input concerning progress speed of the script.
